(19) United States
(12) Patent Application Publication
(10) Pub. No.: US 2009/0249738 A1
(43) Pub. Date: Oct. 8, 2009

(54) Toggle pin

(76) Inventors: Keith Anthony Brereton, Queensland (AU); Craig John Bennett, Queensland (AU); Glen David Janke, Queensland (AU)

Correspondence Address: HOFFMAN WASSON & GITLER, P.C;CRYSTAL CENTER 2, SUITE 522, 2461 SOUTH CLARK STREET, ARLINGTON, VA, 22202-3843, US

(21) Appl. No.: 11/665,178

(22) PCT Filed: Oct. 17, 2005
(86) PCT No.: PCT/AU05/01601

§ 371 Date: May 13, 2009

(30) Foreign Application Priority Data
Oct. 22, 2004 (AU) 2004 -222810

(51) Int. Cl. E04B 1/00; F16B 21/00

(52) U.S. Cl. 52/741.2; 411/344

(57) ABSTRACT

A toggle pin comprising an elongate main body portion having two ends, one end being provided with a passageway that extends at least partially through the main body portion and which is open at the one end such that a line member can pass into the passageway and be connected to the toggle pin, the other end being provided with a toggle plate, the toggle plate being pivoted to the main body portion in such a manner that the toggle plate can move between an unlocking position where the toggle plate is substantially in line with the main body portion, and a locking position where the toggle plate is substantially at right angles to the main body portion.

### FIELD OF THE INVENTION

This invention is directed to a toggle pin and particularly to a toggle pin that can be attached to a wire/cable or similar line member and for use in the construction of rails, fencing, partitioning and the like. The invention will be described with reference to the use of the toggle pin on a wire cable as an infill for balustrading but it should be appreciated that no particular limitation is meant thereby.

### BACKGROUND ART

Balustrading is very common on patios, staircases, verandas and the like. The balustrading typically comprises a top horizontal handrail which is usually made of metal such as steel or aluminium. Often, a bottom horizontal rail is also provided and which is also made of metal such as steel or aluminium. An infill is provided between the top rail and the bottom rail. Traditionally, the infill comprised wooden slats. It is also well known to provide metal bars as the infill. These slats or bars are usually positioned vertically, although it is also known to extend the bars horizontally.

More recently, the use of stainless steel cable has become popular. Typically, a length of stainless steel cable is looped through openings in the top rail and the bottom rail. The threading of the stainless steel cable is a time-consuming and finicky process. Also, tensioning of the cable can be time-consuming and finicky. Should the cable become damaged, it is necessary to unravel the entire length of cable and to replace it with new cable.

It is also known to provide a single length of cable extending between the top rail and the bottom rail and this length of cable can be horizontal or vertical and can have a length of anywhere between 2-5 metres. To provide a proper infill, it is usually necessary to provide between 5-10 lengths of cable spaced apart by a distance of between 50-200 millimetres relative to each other, the cables being parallel relative to each other.

With this type of construction, the top rail needs to be provided with hooks or other forms of attachments that are typically screwed or riveted to the top rail. One end of the cable is then attached to the hook or attachment, typically by being looped around and then twisted about the cable. Sometimes, a clamp of sorts is attached to stop the cable from becoming loose. The other end of the cable is provided with some form of tensioning device such as a turnbuckle. A disadvantage with this arrangement is the need to provide a large number of hooks/attachments, each of which needs to be crewed/riveted to the top rail/post or other suitable mounting area.

Therefore, there would be an advantage if it were possible to provide a way to enable lengths of cable to be quickly attached to a rail/post etc and without the need for riveting, screwing and the like.

It will be clearly understood that, if a prior art publication is referred to herein, this reference does not constitute an admission that the publication forms part of the common general knowledge in the art in Australia or in any other country.

### OBJECT OF THE INVENTION

It is an object of the invention to provide a device that may overcome at least some of the above-mentioned disadvantages or provide the consumer with a useful or commercial choice.

In one form, the invention resides in a toggle pin, the toggle pin comprising an elongate main body portion having two ends, one end being provided with a passageway that extends at least partially through the main body portion and which is open at the one end such that a line member can pass into the passageway and be connected to the toggle pin, the other end being provided with a toggle plate, the toggle plate being pivoted to the main body portion in such a manner that the toggle plate can move between an unlocking position where the toggle plate is substantially in line with the main body portion, and a locking position where the toggle plate is substantially at right angles to the main body portion.

In a broad form, the invention resides in a device to assist in the attachment of a line member to a support, the device having a main body portion, attachment means to enable the line member to be attached to the device, and means which can lock the device to a support in a first orientation and which can release the device from the support in a second orientation.

In this broad form of the invention, the means may comprise a toggle plate pivotly attached to the main body portion and able to pivot between and unlocking position where the toggle plate is substantially in line with the main body portion, and a looking position where the toggle plate is substantially out of line with the main body portion.

In another form, the invention resides in a toggle pin assembly, the assembly comprises a toggle pin as described above and a cable which extends at least partially into the passageway and which can be attached to the toggle pin.

In another form, the invention resides in a method for the manufacture of balustrading, the method comprising providing a first elongate rail and a second elongate rail which are spaced apart, and fitting a plurality of cables between the first elongate rail and the second elongate rail, each cable being fitted to a toggle pin as described above, at least one elongate rail being provided with a plurality of spaced apart openings which are dimensioned to allow the toggle pin to pass into the opening when the toggle plate is in the in line position, and where the toggle plate can then be pivoted to the “out of line” position to lock the toggle pin to the elongate rail.

It can be seen that providing the toggle pin/device greatly simplifies the attachment of cable to the rails /posts etc. All that is required is for the rail/post to be provided with a plurality of openings into which the toggle pin can pass and the toggle plate can then be pivoted to the locking position.

The toggle pin can be used for any type of line member that would benefit from this type of attachment. The line member may comprise a metal cable, metal wire, nonmetal cable/wire, plastic cable/wire, a rope, a strap, a strip, a band, a chain and the like and it is not considered that the invention should be limited to any particular type of line member.

The toggle pin can be attached to a horizontal rail, a vertical post, an angled rail or post member, or any other type of suitable support, and it is not considered that the invention should be limited to any particular type of support to which the toggle pin can be attached.

Typically, the support will be provided with a plurality of openings, and a toggle pin can extend through any of the said openings. The size of the openings will of course depend on the size of the toggle pin but will typically be between 5-20 millimetres. The openings will typically be circular, although it is envisaged that the openings may also be oval, rectangular, or have irregular shapes.

It is also envisaged that, instead of a plurality of openings, the support (e.g. rail, post etc) is provided with one or more elongate slots with the slot width being sufficient to allow the toggle pin to be inserted, but once the toggle plate has been pivoted to the locking position, the toggle pin cannot be removed. With this arrangement, the toggle pin may be configured in such a manner that it does not easily rotate, and this may be achieved by providing an upper part of the toggle pin with a rectangular configuration.

The toggle pin may be made of any suitable material. For aesthetic purposes, the toggle pin may be formed from stainless steel, brass and the like although the toggle pin may be formed from any other type of suitable metal, composite materials, nonmetals and the like.

The toggle pin may have any suitable length and width, depending inter alia on the size of the cable/post etc. For use with balustrading, the toggle pin may have a length of between 30-200 millimetres and preferably between 50-80 millimetres although no particular limitation should be placed on the invention merely by providing these dimensions.

The toggle pin will typically be substantially cylindrical and may have a diameter of between 4-20 millimetres and typically between 5-10 millimetres although no particular limitation should be placed on the invention merely by providing these dimensions. Also, the toggle pin need not be cylindrical and may be square, oval or rectangular in cross-section.

The toggle pin will typically have an elongate main body portion. The main body portion will typically be substantially straight. The main body portion will typically have two ends. One end will typically be open and may be provided with a passageway that extends at least partially through the main body portion. The passageway will typically have a length sufficient to allow a cable/wire to be properly attached to the toggle pin/device.

It is envisaged that the passageway will have a length of between 10-100 millimetres and typically between 30-60 millimetres although this can vary to suit. Alternatively, the length of the passageway may be between 25%-75% of the length of the main body portion.

The elongate passageway will typically be circular in cross-section as this can be quite easily machined. The diameter of the passageway will depend on the size of the cable/wire and will typically be between 2-10 millimetres and preferably between 2-5 millimetres.

The other end of the main body portion may comprise a toggle plate or other type of member that can lock the device into place. If a toggle plate is provided, the toggle plate will typically be pivotly attached relative to the end of the main body portion for movement between a first position where the toggle plate is substantially in line with the main body portion (and therefore can be pushed through an opening/slot in a post/rail), and a second position where the toggle plate locks the device into position.

The toggle plate will typically comprise an elongate member typically formed of metal. The toggle plate may be substantially oval or rectangular in configuration and may have a length of between 5-50 millimetres, a thickness of between 1-5 millimetres, although no particular limitation should be placed on the invention merely by providing these dimensions.

The toggle plate is typically attached to the main body portion in an offset manner, the reason being that the toggle plate will then naturally pivot to the locking position.

Of course, the invention need not be limited to the use of a toggle plate and the invention may extend to any other type of device or means which can expand or change shape etc to enable the pin/device to be locked in place.

### BRIEF DESCRIPTION OF THE DRAWINGS

An embodiment of the invention will be described with reference to the following illustrations in which:.

FIG. 1. Illustrates a toggle pin according to an embodiment of the invention.

FIG. 2. Illustrates three toggle pins attached to a top rail with two toggle pins being in the locking position and the third toggle pin being in the unlocking position.

### DETAILED DESCRIPTION

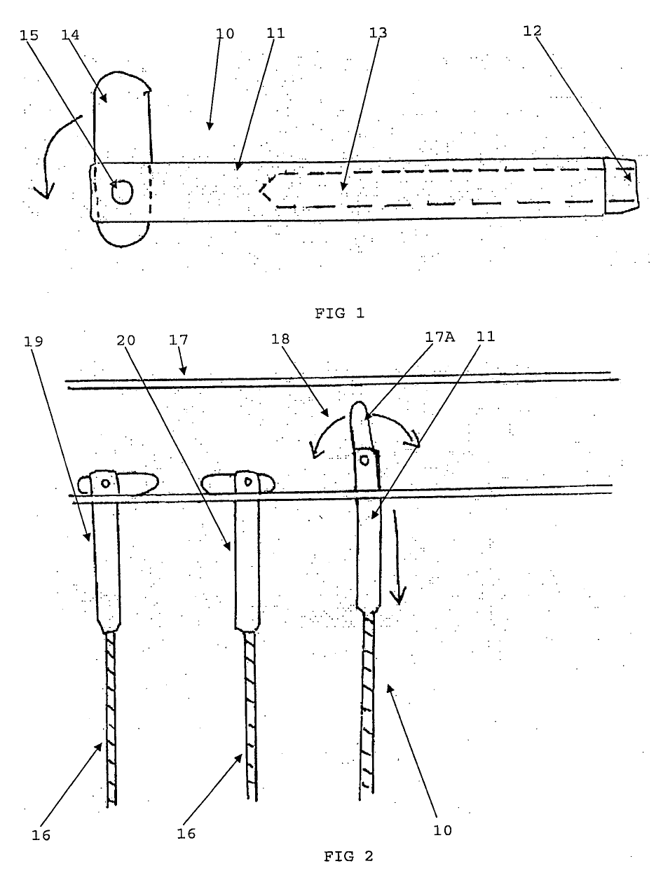

Referring to the illustrations and initially to FIG. 1, there is illustrated a toggle pin 10 according to an embodiment of the invention. The toggle pin comprises an elongate straight main body portion 11 having a length of about 61 millimetres and a diameter of about 5.5 millimetres. The elongate body portion is formed from steel. The elongate body portion has two ends with the “lower” end 12 being open and forming one end of an internal passageway 13 which has a length of slightly over 40 millimetres and a diameter of slightly over 3 millimetres.

The other end of the main body portion is provided with a toggle plate 14. Toggle plate 14 is pivotly attached to the main body portion via pivot pin 15. Typically, a slot is provided in the end of the main body portion and the toggle plate 14 extends through the slot. The toggle plate 14 has a length of about 20 millimetres and a width of about six millimetres. The toggle plate 14 is pivotly attached in an “offset” manner which means that approximately two thirds of the toggle plate extends to one side of the pivot and one third of the toggle plate extends to the other side of the pivot. The reason for this is that the toggle plate will then be weighted to naturally fall to the locking position illustrated in FIG. 1.

In use, a cable 16 (see FIG. 2) is pushed into passageway 13 and the toggle plate is swaged onto the cable via a clamping press.

Referring to FIG. 2, there is illustrated a top rail 17. Top rail 17 is formed with a plurality of openings on the underneath side of the rail. These openings are sized such that when the toggle plate is in the “unlocking” position (see for instance toggle plate 17A in FIG. 2) the toggle plate is substantially in line with the main body portion 11 and therefore can be pushed through the opening in the rail. Once the toggle plate has been pushed into the interior of the rail, the toggle pin 10 can be “jiggled” which will cause the toggle plate to pivot in the direction of arrow 18 to the “locking” position. This locking position is illustrated by toggle pins 19 and 20 in FIG. 2.

The arrangement allows the perimeter frames of balustrading to be curved and fabricated from stainless steel, aluminium, powder coated, galvanised or polished.

The usual conventional type of turnbuckles etc can be positioned on the other end of cable 16 to tension the cable is.

It is found that the arrangement allows the cable infill in balustrading to be done in a much quicker and more efficient manner. Should a cable be damage, it is quite easy to remove the cable from the rail and to replace it with another cable. There is no need to screw or rivet a large number of attachments to the rail. Instead, holes can be drilled into the bottom of the rail, or alternatively the rail can be prepunched with the holes at the required spaced apart positions.

Throughout the specification and the claims (if present), unless the context requires otherwise, the term “comprise”, or variations such as “comprises” or “comprising”, will be understood to apply the inclusion of the stated integer or group of integers but not the exclusion of any other integer or group of integers.

Throughout the specification and claims (if present), unless the context requires otherwise, the term “substantially” or “about” will be understood to not be limited to the value for the range qualified by the terms.

It should be appreciated that various other changes and modifications can be made to any embodiment described without departing from the spirit and scope of the invention.

1. A toggle pin comprising an elongate main body portion having two ends, one end being provided with an axially extending passageway that extends at least partially through the main body portion and which is open at the one end such that a line member can pass into the passageway and be connected to the toggle pin, the other end being provided with a toggle plate, the toggle plate being pivoted to the main body portion in such a manner that the toggle plate can move between an unlocking position where the toggle plate is substantially in line with the main body portion, and a locking position where the toggle plate is substantially at right angles to the main body portion.

2. A toggle pin assembly comprising a toggle pin as claimed in claim 1 and a cable inserted at least partially into the passageway and attached to the toggle pin.

3. A method for the manufacture of balustrading, the method comprising providing a first elongate rail and a second elongate rail which are spaced apart, and fitting a plurality of cables between the first elongate rail and the second elongate rail, each cable being fitted to a toggle pin as claimed in claim 1, at least one elongate rail being provided with a plurality of spaced apart openings which are dimensioned to allow the toggle pin to pass into the opening when the toggle plate is in the in line position, and where the toggle plate can then be pivoted to the “out of line” position to lock the toggle pin to the elongate rail.
